(19) United States
(12) Patent Application Publication
(10) Pub. No.: US 2015/0125602 A1
(43) Pub. Date: May 7, 2015

(54) Methods of Treatment of Ferrous Metal Surfaces and Ferrous Alloy Surfaces

(71) Applicant: John DeLoach, Daisetta, TX (US)

(72) Inventor: Mark Owen Bublitz, South Slocan (CA)

(73) Assignee: John DeLoach, Daisetta, TX (US)

(21) Appl. No.: 14/072,628

(22) Filed: Nov. 5, 2013

(51) Int. Cl. C09D 5/08; C23C 22/78; C23C 22/76

(52) U.S. Cl. CPC C09D 5/08; C23C 22/76; C23C 22/78
USPC 427/248.1; 427/435; 427/429; 427/421.1; 427/327

(57) ABSTRACT

Methods of treating iron-comprising metallic materials by providing an iron-comprising metallic material having one or more surfaces to be treated, contacting the surfaces with a processing agent comprising the processing agent being water-based and containing fee electrons and hydrogen, and allowing electron rich gas from the processing agent to embed into the surfaces to be treated. Methods of inhibiting oxidative electro-chemical corrosion and galvanic corrosion of surfaces of ferrous metal alloys including heating a ferrous metal alloy to produce heated and oil fee surfaces of the alloy, immersing the alloy in an electron rich and hydrogen rich water based treatment agent, and contacting the surfaces of the alloy with gas bubbles comprising electrons generated from the treatment agent.

### TECHNICAL FIELD

The present invention relates to use of an electron rich agent to treat ferrous metals.

### BACKGROUND OF THE INVENTION

Corrosion of metals occurs through the exchange or depletion of electrons. Such oxidation does not always directly involve oxygen. Rather a specific atom undergoes electron loss. Two methods of combating corrosion are cathodic protection and chemical inhibitors. Each of these methods depend upon controlling the charge on a metal surface. Since corrosive attack occurs only at the surfaces of the metal material, any modification of the surface can affect the rate of corrosive activity. Accordingly, it would be advantageous to develop methods to protect metallic surfaces from corrosion.

### SUMMARY OF THE INVENTION

The invention encompasses electron and hydrogen containing, water based agents. Solid silicon rock and sodium hydroxide are mixed with an ammonium/water solution to produce a green liquid in a first stage of the reaction. Alcohol is added and the alcohol fraction is separated from the non-alcohol fraction to produce an alcohol fraction product and a bottom fraction that is not soluble in alcohol or organics. The bottom fraction is treated with water to produce an electron rich processing agent that can be used to inhibit corrosion in ferrous metal alloys.

### BRIEF DESCRIPTION OF THE DRAWINGS

Preferred embodiments of the invention are described below with reference to the following accompanying drawings.

FIG. 1 is a flowchart diagram overview of methodology in accordance with one aspect of the invention.

FIG. 2 shows the reaction of the invention occurring during Reaction Stage I.

FIG. 3 shows the final product produced by Reaction Stage I of the invention.

FIG. 4 displays product separation in Reaction Stage II prior to removal of the uppermost fraction from the bottom fraction.

FIG. 5 shows a ²³Na NMR spectrum of the uppermost fraction product (alcohol soluble fraction) of the invention.

FIG. 6 shows a chart of groups identifiable by infra-red analysis superimposed upon an infrared scan chart (Panel A), and in Panel B, an FTIR spectra comparison of the base product of the invention after reaction stage I (dashed) compared to the polymeric species product (solid) disclosed by Merkl in U.S. Pat. No. 4,029,747 (see Merkl, FIG. 7).

FIG. 7 shows FTIR spectra comparisons of the base product after reaction stage I (dashed) compared to the monomeric species product (solid) disclosed by Merkl in U.S. Pat. No. 4,029,747 (see Merkl at FIG. 3).

FIG. 8 shows and SEM photograph of a liquid mass obtained by drying the green liquid solution at 250° C. for 24 hours.

FIG. 9 shows a flow chart diagram for additional treatment of the lower portion of the initial product.

FIG. 10 shows treatment of a ferrous metal with an electron-rich water-based product in accordance with the invention.

### DETAILED DESCRIPTION OF THE PREFERRED EMBODIMENTS

In general, the invention encompasses agents utilized in treating ferrous metal alloy to inhibit corrosion. Agents are also produced that stabilize amines in solution, methods of forming the agents and methods of utilizing the agents. The agents of the invention are useful in systems where amine treatment is utilized for removal of CO₂ and/or H₂S. More specifically, the agents can be utilized for treatment of natural gas, liquid petroleum gas, combustion gas, flue gases, etc. The agents of the invention can also be utilized for CO₂ capture to produce CO₂ for commercial use. The agents of the invention can additionally be utilized to stabilize amines in solution, including DNA.

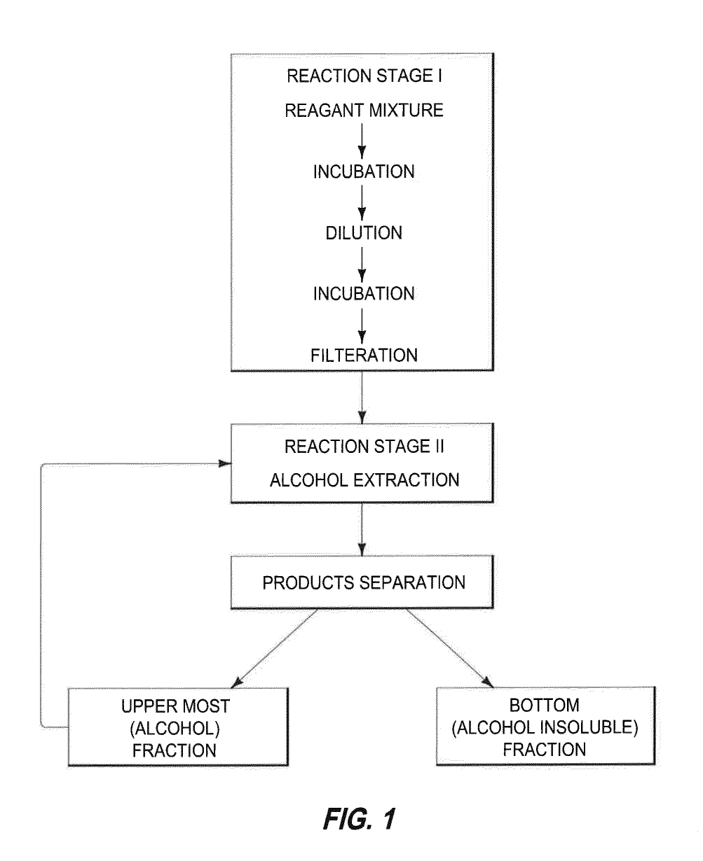

Methods of producing initial agents of the invention are described generally with reference to FIGS. 1-4. Referring initially to FIG. 1, a reagent mixture is formed. An open reaction vessel is provided. Solid silicon in the form of silicon rock is added to the vessel. The size of the silicon rock utilized will be dependent upon the size of the reaction vessel as such affects the heating of the reaction. In a 35 gallon reaction, the average rock size should be about 2 inches diameter and larger. For a 300 gallon reaction, the average rock size should be 4 inches diameter and larger. 98% purity silicon metal may be utilized.

Solid NaOH is added in the form of flakes, pellets or prills. An appropriate ratio of silicon rock to NaOH can be from about 2:1 to about 5:12, by volume. While mixing quickly, a first water-ammonium solution is added to a final concentration of two parts water to one part NaOH, by volume, to form a mixture. The first water ammonium solution contains 5% ammonium hydroxide, mole weight. The ammonium solution is utilized to maintain the reaction temperature at or below 195° F. The addition of ammonium to the mixture introduces free hydrogen, free electron presence and controls heat dissociation of water/sodium hydroxide.

In preferred embodiments a catalyst can be utilized. Appropriate catalysts include, for example, Fe—Ni catalysts and Raney nickel. Where an iron-nickel catalyst is utilized an example catalyst can be 2 grams of iron/nickel oxide per gallon.

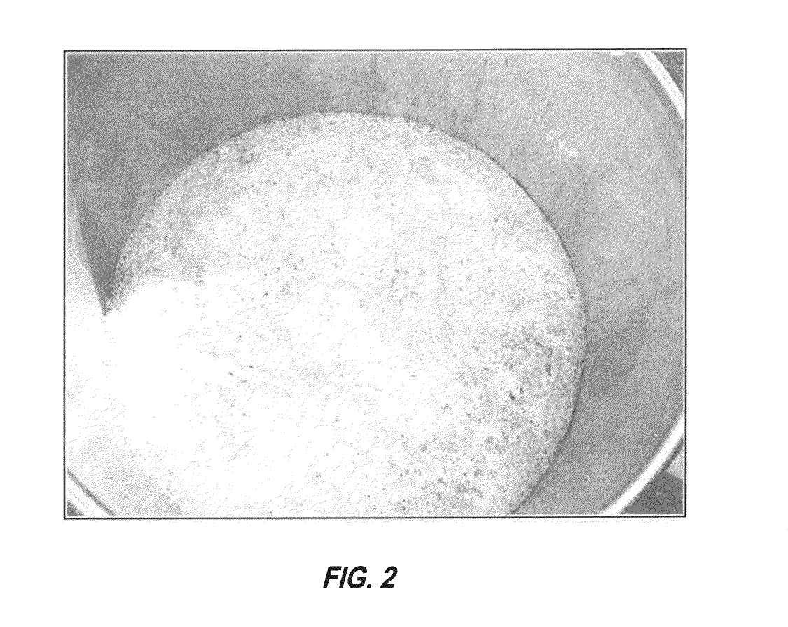

The reaction mixture is allowed to react for a one to two hour incubation period. At about 30 minutes, the reaction will begin to fizz. At about 145° F., the reaction appears to boil. The reaction mixture is very viscous and appears as shown in FIG. 2.

After reacting from about one to two hours, a second water-ammonium solution is added in small aliquots. The second ammonium solution contains 10% ammonium hydroxide, mole weight. The amount of solution added is the minimum sufficient to maintain the temperature of the reaction mixture at or below 195° F. Addition of too much water will kill the reaction. Water-ammonium addition is discontinued upon reaching a four to one ratio of water to sodium hydroxide.

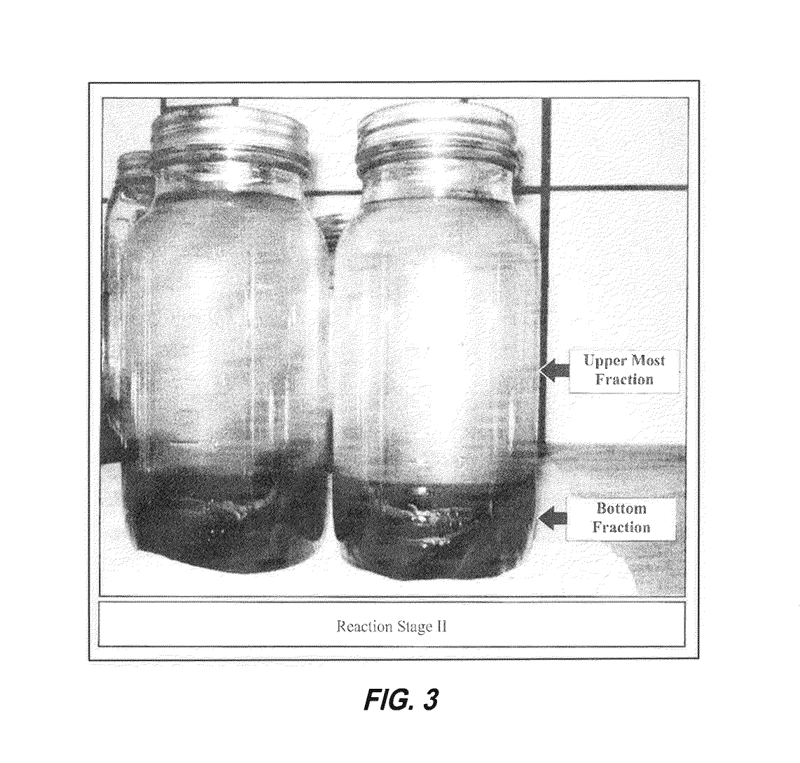

The reaction mixture is allowed to continue to react for from about six to about 8 hours. Upon completion, the reaction mixture will discontinue foaming and be grey/green in appearance as shown in FIG. 3, and has a pH of greater than 14. Water is then added to dilute the mixture and to bring the mixture to a final density of about 1.3 specific gravity. The mixture is allowed to stand for a period of about 24 hours.

After standing, the reaction mixture is filtered to remove the remaining silicon rocks. The filtered product is a green liquid as shown in FIG. 3.

In prior art reference U.S. Pat. No. 4,029,747, issued to Merkl on Jun. 14, 1977, non-alkaline metal was reacted with an alkali metal hydroxide in the presence of aqueous ammonium. In the Merkl reference, the products were a monomeric metal amide complex and an inorganic polymeric complex. The products of the Merkl reference were analyzed by FTIR. The green base product after stage I of the present invention was analyzed by FTIR and a comparison was made to the FTIR spectra presented in Merkl to distinguish the resulting product from that disclosed by Merkl.

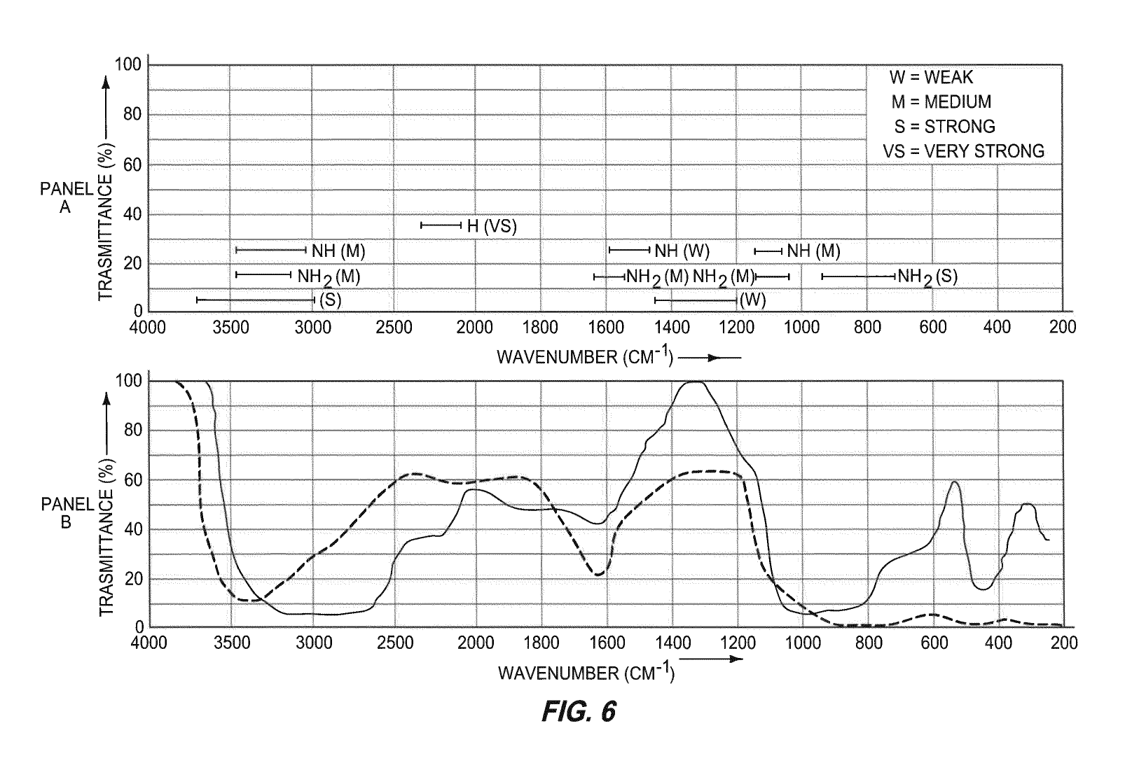

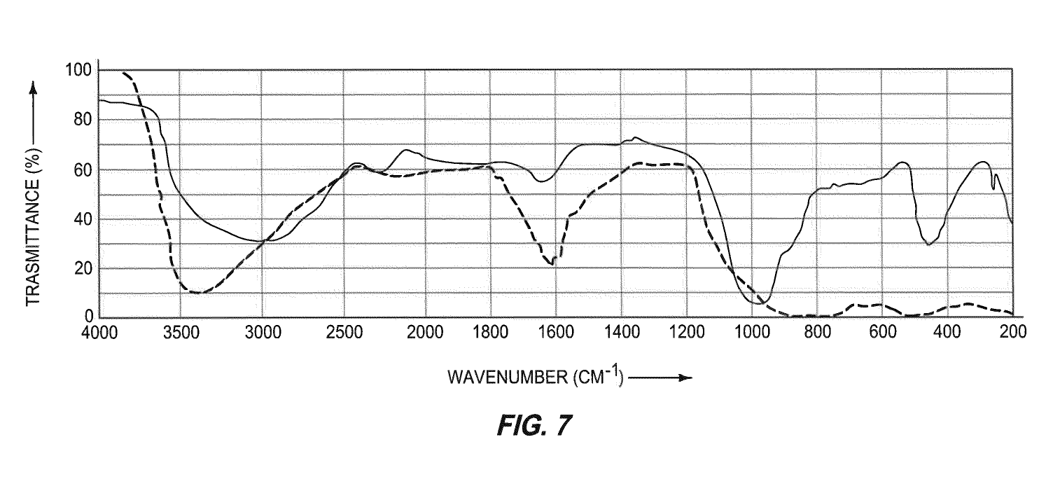

Referring to FIG. 6, such shows a comparison of the FTIR spectrum of the polymeric product of Merkyl (Si—Na liquid system after exothermic phase of reaction) shown in solid, and the FTIR spectrum of the stage I product of the invention, shown in dashed. In FIG. 7, the FTIR spectrum of the stage I product (dashed) is compared to the monomeric product disclosed in Merkl (solid). The comparison confirms that the product of the invention is not the metal amide complex or polymeric complex formed utilizing the methodology disclosed in the Merkyl patent.

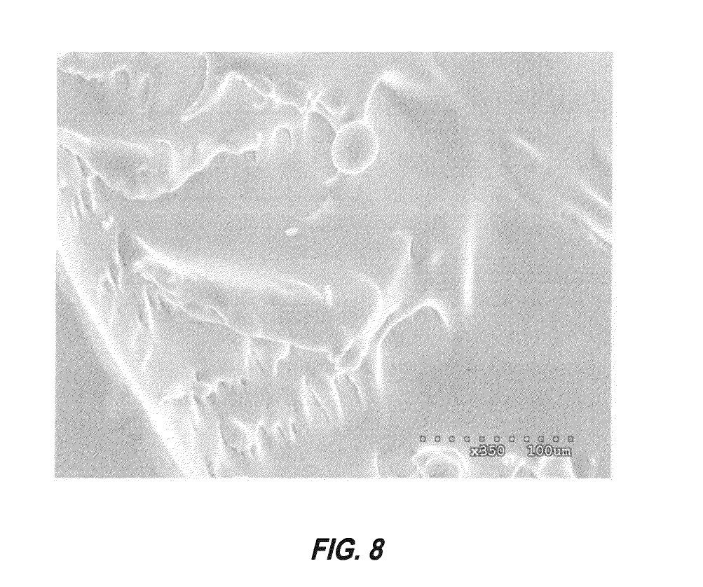

FIG. 8 is an SEM picture of the liquid mass obtained after drying the green liquid at 250° C. for 24 hours.

As shown in FIG. 1, the resulting green liquid is mixed with an alcohol. Alternative volumes of alcohol may be utilized to produce varying product concentration in the alcohol fraction (see below). The volume of alcohol can be from about 10% to about 90%, preferably from about 33% to about 66% of the final alcohol mixture. In particular instances, it can be preferred to add a 50% final volume of alcohol to the green liquid.

The alcohol is not limited to a particular alcohol. In preferred aspects the alcohol can be selected from methanol, ethanol and isopropanol, most preferably ethanol. The resulting mixture is mixed vigorously for five minutes and allowed to stand for at least 24 hours.

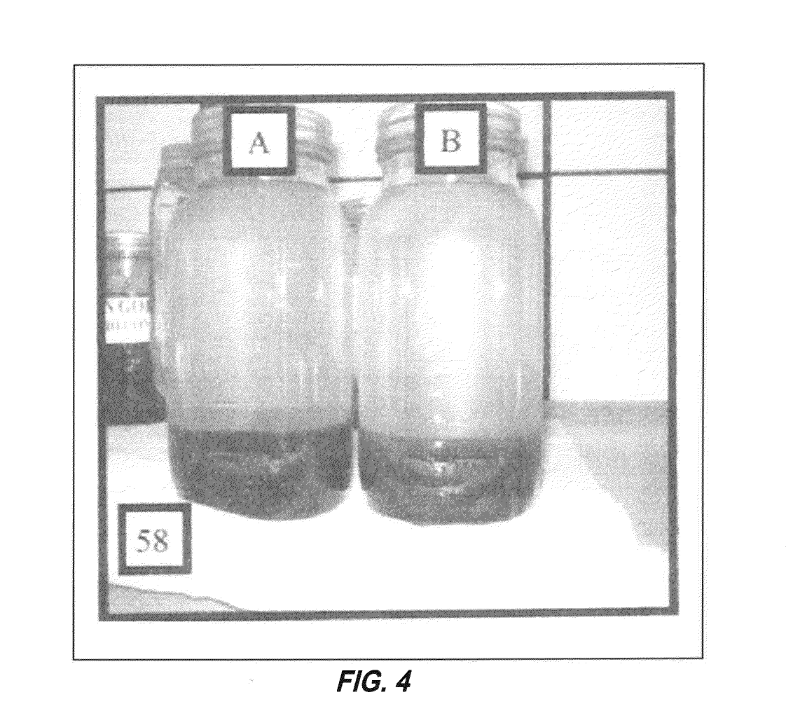

Upon standing, the mixture visibly separates into two distinct product fractions as shown in FIG. 4. 50% of the green liquid is solubilized in alcohol and is present in the upper fraction while 50% is insoluble in alcohol. The uppermost fraction is clear and yellow in appearance with a pH of at least about 13.5, while the bottom fraction (heel) is black and viscous with a pH of greater than or equal to 14. The bottom fraction is insoluble in alcohol.

The two fractions are separated from one another and each are collected as a raw product. The uppermost fraction is filtered.

Each of the uppermost fraction product and bottom fraction product can be utilized to treat fluids for CO₂ removal. The product is added to an amine to form an amine mixture and the amine mixture is utilized to contact a fluid that contains CO₂ to be removed. The fluid can be a gas stream or an emission. The contacting allows CO₂ absorption. Regeneration processing, typically by heating, is conducted to release the CO₂ and regenerate the amine.

Considering first the uppermost (alcohol) fraction, such product contains a sodium species that is contained within liquid water crystals. Alternatively described, the product is an electromagnetic liquid water crystal containing an organized water stabilized sodium, surrounded by an alcohol/water mixture.

Repeated alcohol extraction (Stage II) can be performed as indicated in FIG. 1. The uppermost fraction can be added to the green liquid again to create a two-solution mixture separated based upon density. The bottom layer contains a high silicon and sodium content as the upper layer contains only sodium with a small amount of silicon. By continuously adding uppermost fraction product to the green liquid, the upper layer will eventually contain less ethanol but more sodium-water structure. The density of the two layers eventually becomes equal and separation between layers is no longer visible.

Once density has equalized, the fraction can be cooled to −30° C. and then warmed back up to room temperature. Such processing served to separate all hydrogen bond connections. This process can be repeated until no separation is visible. After continuous cooling and warming, and separating the top liquid from the heel, the top liquid and the heel were each analyzed. The heel consistently showed high sodium and silicon content in a 1-1 mole ratio. The top liquid fraction shows a very low silicon to sodium ratio such that only a minute amount of silicon remains.

After repeated rounds of stage II processing, the resulting alcohol-containing product consists essentially of alcohol, water and sodium surrounded by stabilizing water molecules. The repetition of Stage II can concentrate the sodium/water structure and lower the alcohol content to create a more direct-use product. As the amount of alcohol decreases, separation between layers is eliminated. The stage II processing can be repeated two or more times, and can preferably be repeated up to six times. The final product typically has an alcohol content of 6-9%, by volume.

Analysis of the upper fraction after repeated extraction indicates an ethanol-water solution with a specific gravity of greater than 1.00, a pH of about 14, viscosity of 20 w oil, with sodium as the only major element in the liquid. An example sample contained 10,000 mg/L sodium in 9% ethanol, 91% water. The resulting heel had 110,000 mg/L silicon and 110,000 mg/L sodium. Repeated samples also indicate about equal amounts wt/wt of silicon and sodium in the heel.

The alcohol fraction is an azeotrope having a boiling point of about 80.5° C., above that of ethanol and lower than that of water. The water-stabilized sodium structure is an important part of this ternary azeotrope, affecting the boiling point of the alcohol fraction. The presence of the sodium structure also affects hydrogen bond strengths and lengths.

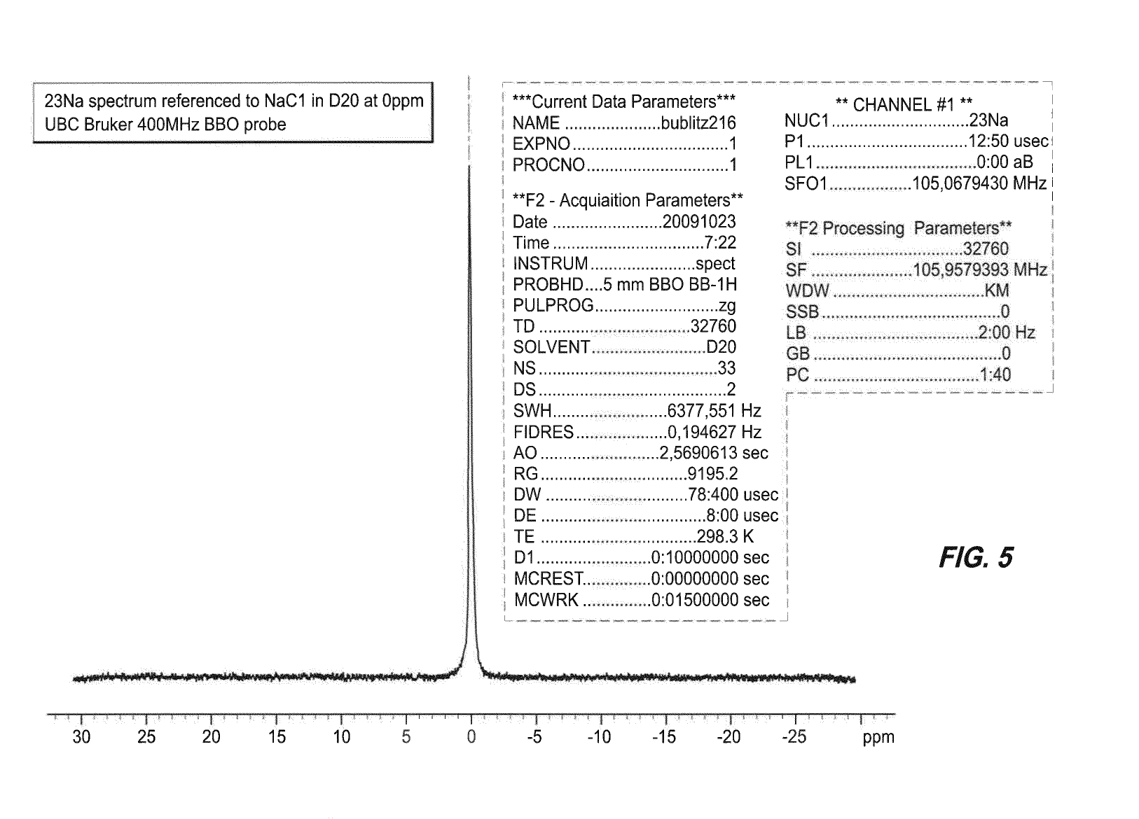

The alcohol/sodium product was analyzed by nuclear magnetic resonance (NMR) spectroscopy ²³Na. As shown in FIG. 5, the ²³Na NMR spectrum has a single spike, indicative of a single sodium species product. It has been assumed that this is a cationic sodium similar to the sodium in sodium chloride. Accordingly, hydrated electrons must be involved in the structure due to the high basicity of the product liquid. It is theorized that this is where the electromagnetic charge originates and stabilizes the liquid structure.

Elemental analysis of the concentrated product after first round of alcohol extraction was conducted. The results are presented in Table I.

TABLE I
Elemental Analysis by ICP-MS analysis

| Lithium (Li) | <0.5 | μg/L |
|---|---|---|
| Beryllium (Be) | <0.05 | μg/L |
| Boron (B) | <0.5 | μg/L |
| Sodium (Na) | 3073 | mg/L |
| Magnesium (Mg) | <0.003 | Mg/L |
| Aluminum (Al) | 0.15 | mg/L |
| Silicon (Si) | 74.5 | mg/L |
| Phosphorous (P) | 0.07 | mg/L |
| Sulfur (S) | 15.8 | mg/L |
| Chloride (Cl) | — | |
| Potassium (K) | 11.6 | mg/L |
| Calcium (Ca) | 0.03 | mg/L |
| Titanium (Ti) | <0.1 | μg/L |
| Vanadium (V) | 20 | μg/L |
| Chromium (Cr) | <0.7 | μg/L |
| Manganese (Mn) | <1.0 | μg/L |
| Iron (Fe) | 0.005 | mg/L |
| Cobalt (Co) | 2.0 | μg/L |
| Nickel (Ni) | <10.0 | μg/L |
| Copper (Cu) | 43.6 | μg/L |
| Zinc (Zn) | 5.0 | μg/L |
| Arsenic (As) | <1.0 | μg/L |
| Selenium (Se) | <7.0 | μg/L |
| Strontium (Sr) | <4.0 | μg/L |
| Molybdenum (Mo) | 40 | μg/L |
| Silver (Ag) | <1.0 | μg/L |
| Cadmium (Cd) | <0.5 | μg/L |
| Tin (Sn) | — | |
| Antimony (Sb) | — | |
| Barium (Ba) | — | |
| Mercury (Hg) | — | |
| Thallium (T) | — | |
| Lead (Pb) | <8.0 | μg/L |

| | |
|---|---|
| Bismuth (Bi) | — |
| Thorium (Th) | — |
| Uranium (U) | — |

After six rounds of stage II extraction, the resulting silicon concentration can be less than 100 mg/L, preferably less than 50 mg/L. It is noted that metals are concentrated in the alcohol fraction while silicon is separated out into the bottom fraction thereby significantly reducing the silicon present in the concentrated final product.

In the purified ethanol product, there exists a sodium water (solvated electron) structure and/or ether-sodium structures and carries an electromagnetic charge (−350 mv) due to its electron rich formation. The electromagnetic liquid has proven to affect internal dispersion forces, weaken the electronegativity of oxygen, affect bonding of lone pairs of electrons, and affects hydrogen bonding in water, alcohols, and amines. During the dissociation reaction in processing to produce the concentrated product, Na+ ions are believed to create broken hydrogen bonds during a high aqueous density. Interactions between water and Na+ are stronger than those between water molecules.

The inert lone pair effect is believed to pay an important role in the properties of the concentrated alcohol product. The inert lone pair effect allows electrons to remain non-ionized, or unshared in compounds, high basicity with lone pair availability. Lone pair effect increases stability of oxidation state, adjusts electronegativity, avoids protonation, in turn avoiding corrosion, realigning dispersion forces of oxygen and nitrogen and creating balance to prevent redox in a corrosive direction.

Basic physical properties of the alcohol/sodium product of the invention are set forth in Table II.

TABLE II

| | Method | | |
|---|---|---|---|
| Property | Used | Results | Unit |
| pH | ASTM | 13.5 | ph |
| | D6423 | | |
| Density @ 15° C. | ASTM | 909.4 | Kg/m³ |
| | D4052 | | |
| Kinematic | ASTM D445 | 2.65 | cSt |
| Viscosity @ 25° C. | | | |
| Freezing point | ASTM | −43.7 | ° C. |
| | D5972 | | |
| Boiling point | ASTM D86 | 79.5 (IBP) | ° C. |
| | | 80.9 (FBP) | ° C. |
| Vapor Pressure, | ASTM D5191 | 38.1 | kPa |
| DVPE | | | |
| Flash Point | ASTM | 20.0 | ° C. |
| | D3828 | | |
| Heat of | ASTM | 17.322 | MJ/kg |
| combustion | D4809 | | |
| (gross) @ 25° C. | | | |
| Water content by | ASTM | 45.289 | Mass % |
| Coulometric Karl | E1064 | | |
| Fischer titration | | | |
| Existent gum | ASTM D381 | 1152.0 | mg/100 mL |
| content | | | |
| Lubricity by high | ASTM | 0.84 major | mm |
| frequency | D6079 | axis | mm |
| reciprocating rig | | 0.84 minor | |
| (HFRR) Wear | | axis | |
| scar diameter @ | | | |
| 25° C. | | | |
| Copper corrosion | ASTM D130 | 1b | |

One use of the alcohol/sodium product is in amine stabilization. The concentrated product can be characterized by a number of factors that play a role in amine stabilization. The product is characterized by hydration of isolated monovalent sodium ions in an aqueous solution. The sodium ions are not fixed in position and are not attached to ions of the opposite charge. The water of the product is dipole stabilized. The high basicity is due to relief of strain on protonation and strong internal hydrogen bonding. High dipole stabilization exists similar to morpholines and piperzines. There exist electrostatic interaction energies from dipole movements in ammonia and amines that correlate with hydrogen bond basicity and restructuring of water into small clusters which relieve surface tension.

Although not intending to be bound by theory, it is theorized that the stabilization of amines and hydrogen bonds in general is due to the product's ability to prevent abstraction of hydrogen from a hydrogen bond. Regardless, the ability of the product to stabilize amines and strengthen hydrogen bonds in general is important to the mechanisms of corrosion prevention, oxidation, and interfacial surface tension dynamics.

The concentrated sodium/water fraction can be utilized as a more direct use product than the product prior to repeated rounds of Stage II treatment. It is also easier to administer and can be utilized for more applications than the initial uppermost fraction. Additionally, smaller quantities of the concentrated product can be utilized, making it easier to administer, store and transport. When the purified alcohol fraction is added to primary or secondary amines the alcohol fraction creates a stable solution with little or no surface tension. The alcohol product of the invention has the effect of strengthening hydrogen bonds and decreasing the number of hydrogen bonds to stabilize the amine. There is a resulting decrease in vapor pressure and a higher boiling point than either the amine or the alcohol fraction. This is supported by pKa readings of the resulting amine/product mixture.

These factors make the sodium/water product ideal for utilization for amine stabilization in amine processing during gas treatment and fuel creation. In gas treatment, the concentrated water/amine product is added to the water preferably prior to blending with the amine to avoid any acid/base shock reaction, especially in the case of a large amount of water/amine mixture being added to the gas treatment facility system as a total change out or conversion.

The concentrated sodium/water product can be added to the water portion of a water/amine mixture to a final concentration of about 1-5%. Alternatively 1-5% by volume of the concentrated sodium/water product can be added to the amine directly. The percentage can be determined by the amine structure and the internal charge needed to stabilize the amine. The stabilization of amines utilizing the alcohol product of the invention additionally reduces the temperatures at which regeneration can occur thereby lowering the expense of amine regeneration.

The basicity of the alcohol fraction product can play an important role during gas processing and CO₂ capture. The basicity prevents acidic protons from being present in the system. Acidic protons present during amine treatment play a role in corrosion, foaming, hydrocarbon saturation, oxygen-salt degradation and product loss; and affects loading and CO₂ release during regeneration. The basicity inhibits formation of acid forming compounds, increases loading capabilities, controls deprotonation of zwitterions reactions, is repulsive to oxygen and sulfur compounds, and effects the temperature of absorption by changing the absorber bulge and maintaining lower temperatures (latent heat).

Considering the concentrated sodium/water product, the trace silicon content and low ethanol level, the product is a nucleophilic catalyst due to the high percentage of water. The product can be diluted up to tenfold and retain enough sodium crystal to maintain a pH above 11.5.

The product's ability to reduce surface tension is also important during gas treatment and CO₂ capture. The lower the surface tension the better the contact for absorption. Lower surface tension also produces lower corrosion of metals, lower energy costs in pumping and regeneration, inhibits hydrocarbon saturation in amine mixture, eases water amine separation in regeneration reflux (to prevent amine carryover into reflux water), and inhibits water from exiting with CO₂ to create a dry CO₂ stream.

The alcohol fraction (or sodium/water fraction) has the ability to prevent solubility of hydrocarbons, thus decreasing hydrocarbon saturation during amine treatment of gases (during amine processing or CO₂ capture), which in turn decreases hydrocarbon losses.

The concentrated product can be added in small to large amounts to hydrogen peroxide and raise the pH to 8.5 or higher without destabilizing the oxygen for uses in oxidative desulphurization of all hydrocarbon structures.

Tests of the alcohol fraction product were performed utilizing an amine treatment facility. The tests indicated reduced foaming, decreased corrosion within the system, less oxidation and degradation of the amine, with less polymerization and formation of heat-stable salts, and dry CO₂ product stream.

The alcohol fraction or diluted form thereof, may be added to any existing amine absorption process without altering any part of the operation structure. Loading and amine concentrations can be increased. The results include decreased foaming, a significant decrease in process energy utilization and decreased product losses. Thus, the alcohol product is useful for treatment of natural gas, liquid petroleum gas and flue gases with lower amine loss, lower degradation, decreased foaming, decreased corrosion and decreased hydrocarbon saturation. These results allow cost savings due to the ability to utilize lower cost amines, the use of decreased or no de-foamers, fewer corrosion inhibitors and longer life of the system, and no need for carbon filters.

Additional advantages afforded with the use of the alcohol fraction product in amine treatment systems include: the ability to use smaller operating facilities due to the ability to utilize increased amine concentration and higher loading; decreased energy usage due to lower heat of dissociation during regeneration; no need for expensive additives; amine life expectancy increased a minimum of tenfold; and CO₂ recovery cost reduction of 300% over competitive products without changing existing operational profile.

The alcohol fraction of the invention can be especially useful for CO₂ capture due to its ability to produce a dry CO₂ product stream, as well as its additional properties set forth above. Table III shows current and emerging solvents utilized for CO₂ capture and costs thereof. As shown, the product of the invention (alcohol/sodium product) is economical and efficient.

TABLE III
Current and emerging solvents for CO₂ capture

| | | Solvent | | Solvent | Steam |
|---|---|---|---|---|---|
| | | loss | Solvent | Cost | Use |
| | | (kg/ton | Cost | ($/ton | (ton/ton |
| | Solvent | CO₂) | ($/kg) | CO₂) | CO₂) |
| Non- | MEA | 1 to 3 | 1.30 | 1.3 to 3.9 | 2.0 |
| proprietary | | | | | |
| Econamine¹ | MEA + | 1.6 | 1.53 | 2.45 | 2.3 |
| | inhibitors | | | | |
| KS-1² | Hindered | 0.35 | 5.00 | 1.75 | 1.5 |
| | amines | | | | |
| PSR³ | Amine | 0.1 to 0.9 | — | — | 1.1 to 1.7 |
| | mix | | | | |
| Praxair⁴ | Amine | 0.5 to 1.5 | 2.00 | 1 to 3 | 1.3 to 1.5 |
| | mix | | | | |
| Sodium/water | Amine | 0.1 to 0.2 | 2.80 | 0.35 | 1.1 to 1.3 |
| product | mix | | | | |

¹Econamine ™, Fluor Corp. 6700 Las Colinas Blvd. Irving TX 75039.
²KS-1 ®, Mitsubishi Heavy Industries, Ltd. Konan 2-chome, Minato-ku Tokyo JAPAN 108-2815.
³PSR ™, Amit Chakma.
⁴Praxair ®, Praxair Technology, Inc. 39 Old Ridgebury Rd. Danbury CT 06810

The sodium/water fraction is also useful in amine-based absorption of CO₂ post combustion from power plant or other emissions (CO₂ abatement). The water/sodium fraction product can be added in place of water in existing amine circulation systems. The result is reduced foaming, decreased corrosion, decreased hydrocarbon saturation and decreased amine degradation. The alcohol fraction or sodium/water product can be utilized in low-pressure, high carbon dioxide streams with an appropriate amine. Types of gases treated may include but are not limited to liquid petroleum gas, natural gas, coal combustion gas, natural gas combustion gas, diesel combustion gas and oil well flare gas.

In one aspect, the concentrated alcohol product can be utilized in concentrated form. In another aspect, the alcohol fraction can be diluted with water prior to use. In another aspect the alcohol fraction or diluted form thereof, can have an appropriate amine or amine mixture added prior to use. Appropriate amines include, for example, MEA, MDEA, DEA, DGA, DIPA, and mixtures thereof. Polypropylene glycol can optionally be added to the mixtures to increase water solubility. Sulfolane can be added to assist in the removal of mercaptans and other sulfur species. It is noted that since the product stabilizes amines and allows easier regeneration, lower cost amines may be utilized in conjunction with the product of the invention.

One example mixture that may be utilized is a mixture of the alcohol fraction (concentrated) with MEA. Uses include, inter alia, utilization as a CO₂ scavenger. For example, this product mixture can be utilized in small production gas wells and main gas transportation lines to lower CO₂ levels. The product mixture can remove up to two moles of CO₂ per mole of product mixture. The product mixture additionally reduces system corrosion (see below).

Another example mixture that can be utilized is 50% concentrated alcohol fraction mixed with 50% triazine. This product mixture can be utilized as an H₂S scavenging liquid. The mixture has a pH of at least 14 with H₂S loading capabilities of up to 4 pounds per gallon of mixture (double the capacity of 100% triazine). The product mixture has a freeze point of below −40° F. which avoids the need to winterize process systems with methanol. This product mixture can be utilized in static mixer designed process systems. The product replaces Sulphatreat® (M-I L.L.C. 5950 North Course Drive, Houston Tex. 77022) and other similar scavenging products that are more expensive.

Table IV Shows a chemical comparison structure between a normal sodium hydroxide liquid to the concentrated sodium/water fraction after repeated stage II processing.

TABLE IV

| | Liquid sodium | |
|---|---|---|
| | hydroxide 50% | Concentrated |
| | NaOH 50% water | water/sodium |
| Boiling point | 4.4° C./40° F. | O ° C./32° F. |
| pH | 13.7 | 13.5 |
| S.G. | 1.53 | 1.04 |
| Corrosivity | Highly Corrosive | Non-Corrosive |
| Sodium content | 500,000 mg/L sodium | 10,000 mg/L sodium |
| Stability | Highly reactive | Non-reactive |
| | High hydroxide | High hydrogen |
| | content | content |

Similar to the alcohol fraction, the sodium/water fraction can be utilized by addition to amine absorption facilities, mixed with an amine, to treat flue gases, natural gas, liquid petroleum gas, etc. Again, the amine may be a low cost amine due to the stabilization afforded by the product. The use of the product results in lower amine loss, decreased degradation, decreased foaming, decreased corrosion, decreased hydrocarbon saturation and increased cost savings relative to alternative amine treatment systems.

The properties of the sodium/water in a CO₂ capture system include enhanced loading capabilities, higher pH, ease of absorption/desorption which in turn decreases energy requirements, improved product purity (water free CO₂), increased amine/water solubility and lower amine loss due to carry over or degradation.

Considering now the bottom (alcohol insoluble) fraction, such comprises a silica hydroxide liquid compound (at room temperature). The bottom fraction, although insoluble in alcohol an organic solvent, is water-soluble. The silica hydroxide-containing bottom fraction can also be utilized to stabilize amines.

The bottom fraction can additionally be utilized as a scrubbing liquid that can be added to water circulation-spray systems in wet scrubbers to remove contaminants from gas streams. The bottom fraction containing liquid silica hydroxide compound can replace troublesome caustic sodas and solid lime with less expense and higher efficiency. The use of this product decreases or avoids process system corrosion by chemically neutralizing the wet scrubbing environment.

In the scrubbing application, small amounts of hydrogen peroxide, sodium hypochlorite and/or ammonium hydroxide can be added to the bottom fraction product to improve activity without affecting the structure of the product.

It is important to note that, in contrast to traditional lime or calcium hydroxide scrubber additives, the present product does not produce gypsum as a byproduct. The byproduct produced utilizing the bottom fraction in scrubbing processes is a nitride/sulfide-based solid that may be utilized for fertilizers. Corrosion in the scrubbing system is decreased or eliminated thereby extending the life of the system components.

The bottom fraction, when added to a scrubbing system, provides an electrostatic environment. The product hinders the formation of acids (such as H₂SO₄) that typically occurs in the wet environment of scrubbing processes. This hindrance is due to the product's ability to affect dispersion forces of non-bonding lone pairs of electrons involved in hydrogen bonding, such as occur in nitrogen, oxygen, sulfur and halogen species. In the presence of the product, high base salts (responsible for degradation) and acids (responsible for corrosion) will be reduced or eliminated.

In another aspect, the bottom fraction can be utilized as part of a mixture in soil washing applications. The mixture can contain from 5% to 50% bottom fraction as an “activator”. The mixture can further contain from 20% to 50% of a catalyst such as H₂O₂, with any balance being water. The resulting mixture is environmentally safe and can be utilized to destroy harmful hydrocarbon structures from soils and/or water sources.

The methodology for hydrocarbon destruction from soils comprises soaking the soil in the above-described mixture and allowing the mixture to evaporate.

This product mixture can additionally be utilized for creation of hydrogen gas, pressure and heat for down-hole enhancement or oil/sand separation without external heat. The amount of heat and pressure will depend upon the peroxide/bottom fraction ratio.

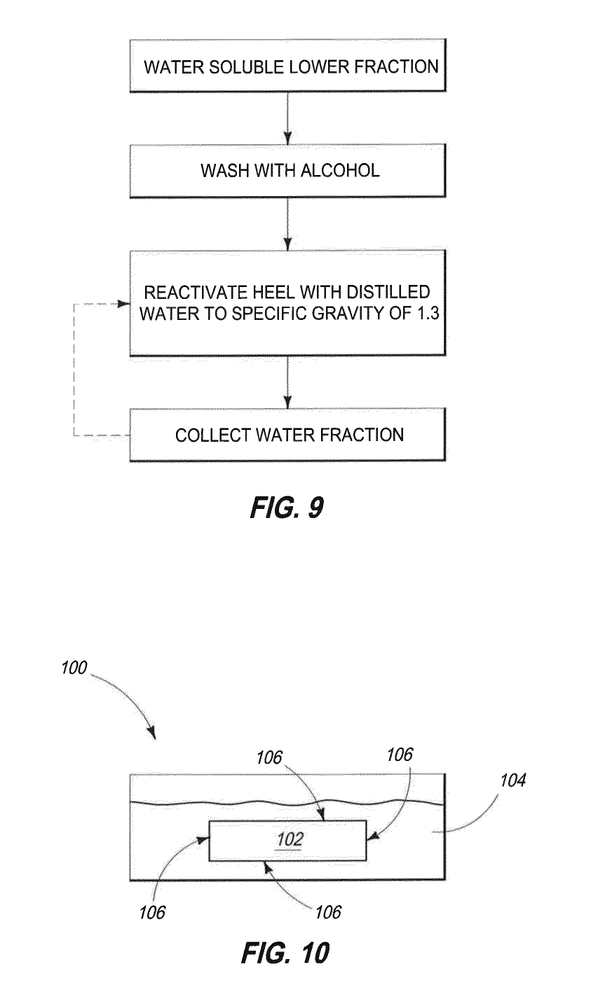

Referring to FIG. 9, such shows additional processing of the water soluble lower fraction. Once the alcohol fraction has been removed, additional washing with alcohol can be performed to remove sodium. The heal is then reactivated with distilled water to a specific gravity of 1.3. The water fraction is collected. Repeated rounds of reactivation with distilled water can be utilized. The resulting water product is light gold and contains free electrons as well as hydrogen. The resulting water-based product can be diluted with water us to 300 fold prior to use.

Analysis of the metal content of the water fraction was performed by ICP-AES, ASTM D 1976 the results of which is presented in Table V.

TABLE V

| Metal | mg/L |
|---|---|
| Silver | <1.0 |
| Aluminum | <1.0 |
| Arsenic | <1.0 |
| Boron | 0.43 |
| Barium | 0.36 |
| Beryllium | <1.0 |
| Calcium | <1.0 |
| Cadmium | <1.0 |
| Chromium | <1.0 |
| Copper | <1.0 |
| Iron | <1.0 |
| Potassium | <1.0 |
| Lithium | <1.0 |
| Magnesium | <1.0 |
| Manganese | <1.0 |
| Sodium | 9.429 |
| Nickel | <1.0 |
| Lead | <1.0 |
| Antimony | <1.0 |
| Selenium | <1.0 |
| Silicon | 2159 |
| Tin | <1.0 |
| Titanium | <1.0 |
| Vanadium | <1.0 |
| Zinc | <1.0 |

The supernatant product was also determined to contain 20.125 mg/L bicarbonate. The pH of the undiluted sample (mixed supernatants) was 13.11. After dilution 300 fold with water, the pH was 10.79. The results for analysis of anion content determined by ASTM D 4327b are shown in Table VI.

TABLE VI

| Anion | mg/L |
|---|---|
| Chloride | 26.6 |
| Nitrite | <1.0 |
| Bromide | 14.6 |
| Nitrate | <1.0 |
| Sulfate | 1.9 |

A Karl Fischer test was performed and showed that there are excess electrons in the sample. An alkalinity test also showed an absence of hydroxides, an absence of carbonates, and very few bicarbonates. The combined results indicate the sample is a reduced water structure with hydrated electron presence.

The resulting viscous aqueous solution has contents that readjust the surrounding water into an electron reduced water structure. The concentrate can be diluted with deionized water, water treated by reverse osmosis, or distilled water by a dilution factor of from 10 to 500 pars water to 1 part product. This dilution product can be utilized to treat ferrous metal materials and will release a condensate, steam or gas of high electron content magnetically directed toward heated ferrous metal. The dilution product can penetrate surfaces of the metal and neutralize the conductive surface.

The dilution product is designed to be utilized as a cooling liquid in quenching or temper treating ferrous metals. The ferrous metal is preferably heated prior to treatment and has surfaces free of any oils. Referring to FIG. 10, treatment 100 preferably involves immersing the metal material 102 in the treatment agent 104. Alternatively, brushing, misting, or spraying on can be utilized. Treatment with this product creates a non-conductive, electron rich surface 106 that avoids electrochemical oxidation and in turn inhibits corrosion.

During the treatment with the electron rich product, small bubbles 108 of substantially equivalent size are generated and form on or contact the surfaces 106 of metallic material 102. The bubbles are electron rich and reduce the conductivity of the surfaces. The bubbles eventually disappear once the metal material reaches the temperature of the treatment product. The contacting with bubbles demagnetizes and depolarizes the metallic material thereby reducing electrochemical oxidation, galvanic and oxidative corrosive processes and magnetic drag in the metallic material.

It is important not to over-heat the metal prior to treatment. An appropriate temperature of the metal can be from about 60° C. to about 180° C. Additionally, immersion should be controlled. The treatment product should be monitored to maintain an oxidation/reduction potential of at most 100 and a pH of at least 10.5. If the pH falls below 10.5, additional concentrated product can be added. If the oxidation/reduction potential becomes higher than 100, the treatment solvent should be discarded.

The invention claimed is:

1. A method of treating iron-comprising metallic materials, comprising;
providing an iron-comprising metallic material having one or more surfaces to be treated;
contacting the surfaces with a processing agent comprising the processing agent being water-based and containing fee electrons and hydrogen; and
allowing electron rich gas from the processing agent to embed into the surfaces to be treated.

2. The method of claim 1 wherein the contacting demagnetizes and depolarizes the metallic material thereby reducing electrochemical oxidation, galvanic and oxidative corrosive processes and magnetic drag in the metallic material.

3. The method of claim 1 wherein the contacting comprises one or more of submersion, misting, spraying or brushing on of the processing agent.

4. The method of claim 1 further comprising heating of the metallic material prior to the contacting.

5. The method of claim 4 wherein treatment produces substantially equivalently sized gas bubbles that slowly decrease in number as the metal reaches the temperature of the processing agent.

6. The method of claim 5 wherein the gas bubbles are electron rich and penetrate the surfaces of the metallic material.

7. The method of claim 4 wherein the heating raises the temperature of the metallic material to a temperature of from 60° C. to 180° C.

8. The method of claim 1 wherein the contacting reduces hydrogen embrittlement occurrence on the surfaces of the metallic material.

9. The method of claim 1 wherein surfaces of the metallic material are oil free at the time of treatment.

10. A method of inhibiting oxidative electro-chemical corrosion and galvanic corrosion of surfaces of ferrous metal alloys, comprising:
heating a ferrous metal alloy to produce heated and oil fee surfaces of the alloy;
immersing the alloy in an electron rich and hydrogen rich water based treatment agent; and
contacting the surfaces of the alloy with gas bubbles comprising electrons generated from the treatment agent.
